(19) United States
(12) Patent Application Publication
(10) Pub. No.: US 2017/0136589 A1
(43) Pub. Date: May 18, 2017

(54) SYSTEM AND METHOD FOR REPAIRING A SEAM OF A HEAT EXHCANGE SYSTEM

(71) Applicant: SABIC GLOBAL TECHNOLOGIES B.V., Bergen op Zoom (NL)

(72) Inventors: Zachariah SELVARAJAN, Jubail (SA); Gys Van ZYL, Jubail (SA)

(21) Appl. No.: 15/323,179

(22) PCT Filed: Jul. 2, 2015
(86) PCT No.: PCT/IB2015/055008

§ 371 Date: Dec. 30, 2016

Related U.S. Application Data
(60) Provisional application No. 62/020,564, filed on Jul. 3, 2014.

(51) Int. Cl. B23P 15/26; F28F 11/00; F28F 9/00; B23P 6/00; F28D 7/16

(52) U.S. Cl. CPC B23P 15/26; B23P 6/00; F28D 7/16; F28F 9/00; F28F 11/00; F28F 2230/00; F28F 2265/16

(57) ABSTRACT

Techniques for repairing a shell and tube heat exchange device including a housing having at least a first member and a second member disposed along a longitudinal side thereof are provided. A partial pipe is provided having a first end, a second end, and a continuous interior surface. The partial pipe is coupled to the housing transverse to the longitudinal direction. The first end of the partial pipe is coupled to the first member and the second end of the partial pipe is coupled to the second member to define a cavity between the continuous interior surface of the partial pipe and the longitudinal side of the exchange device and to prevent leakage of the exchange device.

### TECHNICAL FIELD

The disclosed subject matter relates to the design, fabrication, use and repair of heat exchange systems.

### BACKGROUND

A heat exchanger is a device for transferring the heat of one substance to another. Certain heat exchange devices include a shell and tube heat exchange device. Unfortunately, heat exchange devices can sustain damage through wear and tear after a period of time. As such, damage (e.g., leaking) can occur in the weld seams of the exchange device or pressure vessel. One practice to repair such damage is to grind and restore the damaged component to original dimensions by weld build-up. For large vessels with a large wall thickness, such a repair action can be very expensive both in terms of repair cost and consequential losses (production loss due to downtime).

In fixed tube heat exchange devices, the longitudinal pressure thrust load on the shell side of the heat exchange device is carried by both the heat exchange device shell and the tube bundle. Depending on the specifics of the design, the tube bundle of the heat exchange device may be strong enough to carry the full pressure thrust load, in the event that a circumferential seam becomes completely damaged. In such case, ensuring the integrity of the pressure boundary is reduced to the problem of containing the leak in a damaged weld seam. A full weld repair of the damaged seam can be conducted, which can result in expense and equipment downtime during the repair.

There remains a continued need for an efficient and economic system for repair of heat exchange systems.

### SUMMARY

Disclosed herein are systems and methods for repairing a shell and tube heat exchange device.

According to an embodiment of the disclosed subject matter, systems for repairing a shell and tube heat exchange device are provided. An exemplary system includes a shell and tube heat exchange device having a longitudinal dimension and a housing. The housing has at least a first member and a second member disposed along a longitudinal side of the exchange device. A partial pipe is further provided having a first end, a second end, and a continuous interior surface. The partial pipe is coupled to the housing transverse to the longitudinal direction, where the first end of the partial pipe is coupled to the first member and the second end of the partial pipe is coupled to the second member to define a cavity between the continuous interior surface of the partial pipe and the longitudinal side of the exchange device and to prevent leakage of the exchange device.

In accordance with another aspect of the disclosed subject matter, methods of repairing a shell and tube heat exchange device are further provided. An example method includes providing a shell and tube heat exchange device having a longitudinal dimension and a housing. The housing has at least a first member and a second member disposed along a longitudinal side of the exchange device. The method further includes coupling a partial pipe to the housing transverse to the longitudinal direction, where the partial pipe has a first end, a second end, and a continuous interior surface. The first end of the partial pipe is coupled to the first member and the second end of the partial pipe is coupled to the second member to define a cavity between the continuous interior surface of the partial pipe and the longitudinal side of the exchange device and to prevent leakage of the exchange device.

It is to be understood that both the foregoing general description and the following detailed description and drawings are examples and are provided for purpose of illustration and not intended to limit the scope of the disclosed subject matter in any manner

The accompanying drawings, which are incorporated in and constitute part of this specification, are included to illustrate and provide a further understanding of the devices of the disclosed subject matter. Together with the description, the drawings serve to explain the principles of the disclosed subject matter.

### BRIEF DESCRIPTION OF THE DRAWINGS

The subject matter of the application will be more readily understood from the following detailed description when read in conjunction with the accompanying drawings, in which:

FIG. 1 is a partial cross-section and perspective view of a shell and tube heat exchange device, according to an embodiment of the disclosed subject matter.

FIG. 2 depicts a side cross-sectional view of the heat exchange device of FIG. 1 with at least one partial pipe coupled to the housing of the heat exchange device, according to an embodiment of the disclosed subject matter.

FIG. 2A depicts a side cross-section view of a detail of FIG. 2 wherein a partial pipe is coupled to the housing of the heat exchange device, according to an embodiment of the disclosed subject matter.

FIG. 2B depicts a side cross-section view of a detail of FIG. 2 wherein a partial pipe is coupled to two panels of the housing of the heat exchange device, according to an embodiment of the disclosed subject matter.

FIG. 3 depicts a further detail of a partial pipe coupled to the housing of a heat exchange device, according to an embodiment of the disclosed subject matter.

### DETAILED DESCRIPTION

The presently disclosed subject matter provides techniques for repairing a shell and tube heat exchange device that has suffered a structural failure at a seam of the heat exchange device. The disclosed systems and methods can also be used to prevent structural failure of the shell and tube heat exchange device by prophylactically installing the partial pipes about the seams of the heat exchange device. The disclosed subject matter provides techniques for repairing heat exchange systems that assure structural integrity of damaged circumferential weld seams in the shell side of a shell-and-tube heat exchange device while avoiding the need to perform a full weld repair. Under appropriate conditions, the damaged circumferential weld seam can be enclosed with a partial pipe creating a configuration similar in some respects to a shell side expansion joint. The disclosed subject matter provides for the use of such partial pipe to cover a damaged circumferential weld seam and retain the pressure boundary in a structurally sound manner By installing a partial pipe or hollow semi-cylindrical shape over the weld seam around the circumference of the shell, leaks or fissures that form in the weld seam can be contained in the annular space/cavity inside the partial pipe.

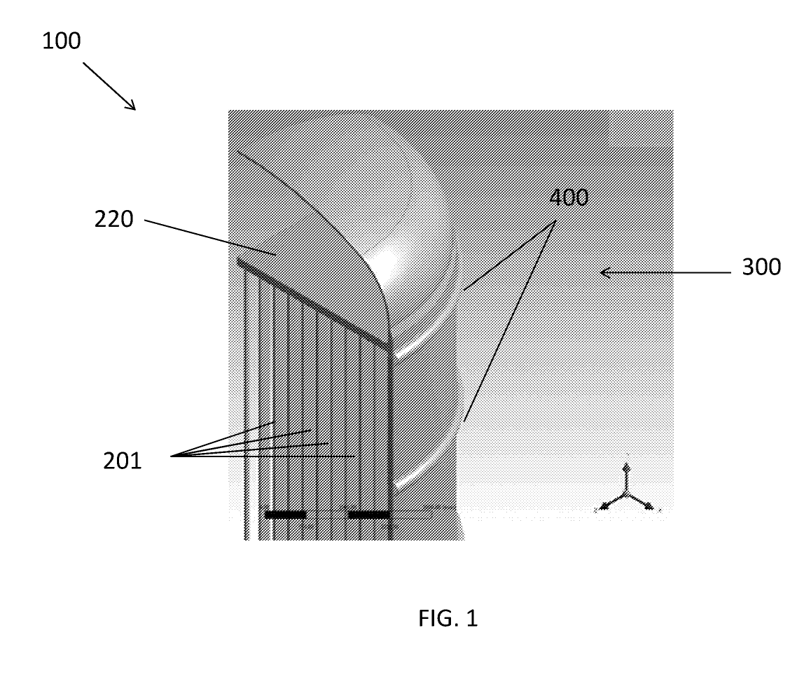

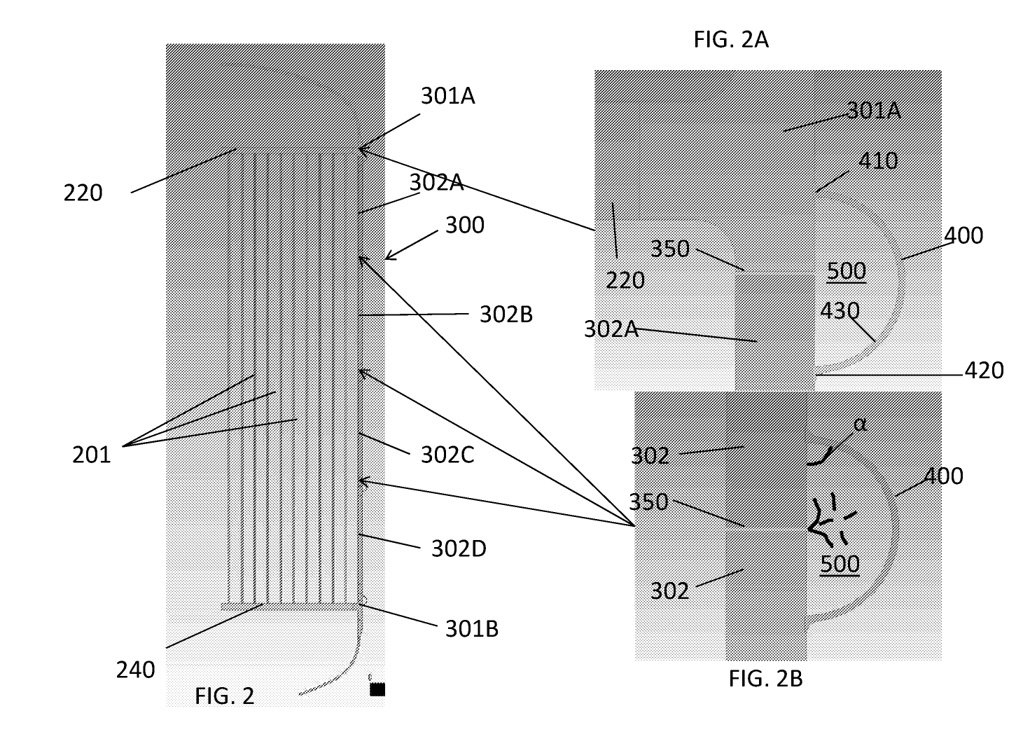

FIG. 1 shows a partial cross-section and perspective view of an illustrative shell and tube heat exchange device 100, according to an embodiment of the disclosed subject matter. The shell and tube heat exchange device 100 includes a plurality of tubes 201, a first tube sheet 220, and a second tube sheet 240 (see FIG. 2). FIG. 2 depicts a side cross-sectional view of the heat exchange device of FIG. 1. As shown, the plurality of tubes 201 are coupled to and extend between the first tube sheet 220 and the second tube sheet 240. The plurality of tubes 201 can be coupled to the first and second tube sheets 220, 240 by any suitable manner as recognized in the industry. A first medium flows within the plurality of tubes at a tube side of the heat exchange device. A second medium flows exterior to the plurality of tubes within the housing at a shell side of the heat exchange device. The first and second mediums can be any suitable medium as known in the industry. For example, the mediums can be water, gas, and other fluids as known in the industry. The first and second medium can be the same or can be different mediums. As understood by persons of ordinary skill in the art, the first medium within the tubes at the tube side can be used to heat or cool the second medium surrounding the tubes at the shell side, or vice versa.

The shell and tube heat exchange device can be any size, dimension, and shape. As depicted in FIG. 1, the heat exchange device is shown as a cylinder but any suitable shape is contemplated herein.

As used herein, the term “about” or “approximately” means within an acceptable error range for the particular value as determined by one of ordinary skill in the art, which will depend in part on how the value is measured or determined, i.e., the limitations of the measurement system.

The shell and tube heat exchange device 100 has a longitudinal dimension and a housing. The plurality of tubes 201 extend in the longitudinal direction. The housing 300 surrounds the plurality of tubes 201 and provides the casing of the shell and tube heat exchange device 100. The housing and shell side of the heat exchange device is designed to withstand a pressure load as desired.

The sidewall of the housing can include one or a plurality of panels and can also include one or more brackets. FIG. 2 shows the sidewall of the exchange device having at least four panels 302A, 302B, 302C, and 302D and at least two brackets 301A and 301B. With the panel(s) and/or the bracket(s), the housing has at least a first member and a second member disposed along a longitudinal side of the exchange device.

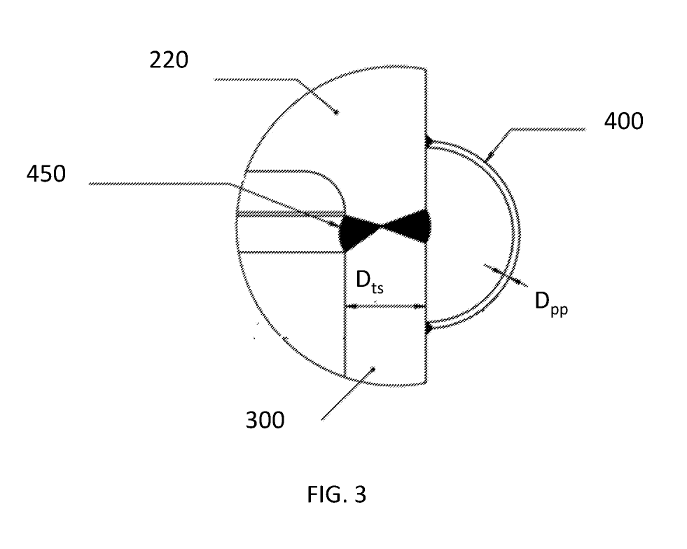

FIG. 2A depicts a side cross-section view of a detail of FIG. 2 where the first member and the second member together define a seam 350 where the members converge. The first member and the second member are coupled together by any suitable manner as known in the art, such as, but not limited to welding, soldering, adhering, and the like. In the example of FIG. 2A, the first member is a bracket 301A and the second member is a panel 302A. The bracket 301A couples the first tube sheet 220 to the housing. FIG. 2B depicts another side cross-section of details of FIG. 2 wherein the first member and the second member are both panels 302. In other embodiments, the tube sheet can be monolithic with the sidewall of the housing, as shown in FIG. 3 and further discussed herein.

With wear and tear of the heat exchange device, the seam between the first member and the second member can become compromised. Unfortunately, fissures or leaks can develop at the seam that can alter a pressure within a shell side of the heat exchange device. As such, the plurality of tubes 201 is designed to withstand pressure alterations in the event that a leak occurs. To repair the seam between the first member and the second member, a partial pipe is installed with the shell and tube heat exchange device. The partial pipe can be installed circumferentially about the heat exchange device at the seam.

As demonstrated herein, the pressure within the heat exchange device can be handled by shifting the pressure exterior to the leaking segment of the housing and into the cavity defined by the partial pipe. By having substantially similar internal pressure and external pressure at the leak location, there is a substantially zero differential pressure at the leak location. As such, having a slightly higher pressure external to the pipe can facilitate a lower actual internal pressure within the heat exchange system.

FIG. 1 depicts two partial pipes 400 circumferentially installed to the heat exchange device 100 about two seams. FIG. 2A depicts the cross-sectional detail of the top partial pipe of FIG. 1. As shown in FIG. 2A, the partial pipe 400 has a first end 410, a second end 420, and a continuous interior surface 430. The partial pipe 400 is coupled to the housing transverse to the longitudinal direction. The first end 410 of the partial pipe is coupled to the first member 301A and the second end 420 of the partial pipe is coupled to the second member 302A to define a cavity 500 between the continuous interior surface 430 of the partial pipe and the longitudinal side of the exchange device.

The first end 410 and the second end 420, respectively, can be positioned at an angle a to the first member and second member. In FIG. 2A and 2B, the angle a of first end 410 and the second end 420 is approximately 90° with respect to the first member and second member. However, the angle a can include any suitable angle that will facilitate the partial pipe being coupled appropriately to the housing, provided that the seam is inside the area covered by each end of the partial pipe. The partial pipe contains any fissures of the housing between the first end and the second end of the partial pipe and prevents leakage of the exchange device to an external environment. The partial pipe can also be installed for prophylactic measure, absent any leaks. The partial pipe can be coupled to the first member and the second member by any suitable manner such as but not limited to at least one of weld, solder, adhesive, and the like. An example of a suitable adhesive includes LOCTITE™ as manufactured by the Henkel Corporation, such as Loctite 495: Super Bonder Instant Adhesive. Other brand adhesives which can maintain adhesive properties when pressed or under force, such as silicone rubber, are furthermore contemplated herein.

FIG. 2B shows the side cross-sectional view of the details of FIG. 2 wherein ends of a partial pipe 400 is coupled to two panels 350 of the housing, respectively. In the example of FIG. 2B, a leak is shown such that the second medium in the shell side of the housing enters the cavity 500. As shown, the continuous interior surface of the partial pipe is uninterrupted in order to contain the second medium therein. As such, the partial pipe does not include holes permitting the cavity to have exposure to the external environment surrounding the heat exchange device. The partial pipe can extend circumferentially about the entire circumference of the heat exchange device and transverse to the longitudinal dimension of the heat exchange device. The partial pipe can additionally include a seal device to prevent any leakage from the cavity 500.

FIG. 3 depicts another example and further detail of a partial pipe 400 coupled to the housing 300 of a heat exchange device having a first tube sheet 220. The first tube sheet 220 has a diameter, Dₜₛ. The damaged circumferential seam 450 is covered by a partial pipe 400 formed circumferentially and having a similar diameter, Dₚₚ, as the outer circumference of the housing. The partial pipe is coupled by a weld in this embodiment to the shell housing on either side of the damaged weld seam to form a pressure-tight enclosure over the weld seam 450. In this embodiment, the tube sheet is monolithic or integral with the side panel of the housing, as shown.

With leaks at the seams of the housing and other stresses, the heat exchange device can structurally deform. As such, the sidewall of the housing can also experience deformation. As such, the partial pipe comprises a flexibility profile that enables the partial pipe to maintain structural integrity upon deformation of the housing and/or sidewall. The partial pipe can comprise any suitable material that can maintain structural integrity while be coupled to members subject to deformation and withstand such pressures. In one embodiment, the partial pipe includes a metal. The metal can include any suitable metal, such as, for purposes of example and not limitation, carbon steel, stainless steel, steel, combinations thereof or any available metals or materials that can be welded.

The partial pipe includes a curved configuration to match a configuration of the cylindrical housing, although any suitable configuration is contemplated herein. Any size or configuration of the partial pipe can be used, provided that the leaking or damaged section is covered by the respective ends of the pipe. In some embodiments, for ease of fabrication and installation, circular, oblong, and rectangular shapes can be suitable for the partial pipe.

The size of partial pipe can depend on the size of circumferential seam. Larger separation between the first member and the second member can necessitate a wider diameter partial pipe to encircle the seam. The partial pipe can include any suitable dimension to accommodate a leak at a leak location at the seam, including a suitable length and thickness. In one embodiment, the partial pipe has a thickness dimension that can be dependent on a pressure capacity of the shell side of the heat exchange device. For example, for heat exchange devices having high temperate ranges and a high pressure capacity, the partial pipe can proportionately have a greater strength due to the material properties of the partial pipe such as for purposes of example, being metal. In contrast, for heat exchange devices having lower pressure capacity, the partial pipe can have lesser thickness dimension. The thickness of the partial pipe can be approximately the same thickness as the first and second members. Alternatively, the thickness can also vary. The minimized thickness of the partial pipe facilitates greater ease in the fabrication, handling, and installation of the partial pipe and affects the flexibility profile of the partial pipe. In the example of FIG. 3, the partial pipe has a thickness of approximately 9 mm.

Details regarding the method of the disclosed subject matter are understood from the detailed description above. Generally, however, a method of repairing a shell and tube heat exchange device is further provided. The method includes providing a shell and tube heat exchange device having a longitudinal dimension and a housing. The housing has at least a first member and a second member disposed along a longitudinal side of the exchange device. The method further includes coupling a partial pipe to the housing transverse to the longitudinal direction, wherein the partial pipe has a first end, a second end, and a continuous interior surface. The first end of the partial pipe is coupled to the first member and the second end of the partial pipe is coupled to the second member to define a cavity between the continuous interior surface of the partial pipe and the longitudinal side of the exchange device and to prevent leakage of the exchange device.

The systems and methods disclosed herein include at least the following embodiments:

### Embodiment 1

A system for repairing a shell and tube heat exchange device, comprising: a shell and tube heat exchange device having a longitudinal dimension and a housing, the housing having at least a first member and a second member disposed along a longitudinal side of the exchange device; and a partial pipe having a first end, a second end, and a continuous interior surface, the partial pipe coupled to the housing transverse to the longitudinal direction, wherein the first end of the partial pipe is coupled to the first member and the second end of the partial pipe is coupled to the second member to define a cavity between the continuous interior surface of the partial pipe and the longitudinal side of the exchange device and to prevent leakage of the exchange device.

### Embodiment 2

The system of Claim 1, wherein the shell and tube heat exchange device includes a plurality of tubes, a first tube sheet, and a second tube sheet, wherein the plurality of tubes are coupled to and extend between the first tube sheet and the second tube sheet.

### Embodiment 3

The system of Claim 2, wherein a first medium flows within the plurality of tubes at a tube side of the heat exchange device and a second medium flows exterior of the plurality of tubes within the housing at a shell side of the heat exchange device.

### Embodiment 4

The system of any of Claims 1-3, wherein the shell side withstands a predetermined pressure load.

### Embodiment 5

The system of any of Claims 1-4, wherein the first member and the second member define a seam.

### Embodiment 6

The system of Claim 5, wherein the seam includes a fissure that alters a pressure within a shell side of the heat exchange device and the plurality of tubes withstand the pressure alteration.

### Embodiment 7

The system of Claim 6, wherein the partial pipe contains the fissure between the first end and the second end of the partial pipe.

### Embodiment 8

The system of any of Claims 1-7, wherein the partial pipe comprises a flexibility profile that enables the partial pipe to maintain structural integrity upon deformation of the housing.

### Embodiment 9

The system of any of Claims 1-8, wherein the partial pipe comprises steel.

### Embodiment 10

The system of any of Claims 1-9, wherein the first member comprises a bracket that couples at least one of the first tube sheet or the second tube sheet to the housing.

### Embodiment 11

The system of any of Claims 1-10, wherein the first member and the second member each comprise a panel of the housing.

### Embodiment 12

The system of any of Claims 1-11, wherein the partial pipe is coupled to the first member and the second member by at least one of weld, solder, and adhesive.

### Embodiment 13

The system of any of Claims 1-12, wherein the continuous interior surface of the partial pipe is uninterrupted.

### Embodiment 14

A method of repairing a shell and tube heat exchange device, comprising: providing a shell and tube heat exchange device having a longitudinal dimension and a housing, the housing having at least a first member and a second member disposed along a longitudinal side of the exchange device; and coupling a partial pipe to the housing transverse to the longitudinal direction, wherein the partial pipe has a first end, a second end, and a continuous interior surface, the first end of the partial pipe coupled to the first member and the second end of the partial pipe coupled to the second member to define a cavity between the continuous interior surface of the partial pipe and the longitudinal side of the exchange device and to prevent leakage of the exchange device.

### Embodiment 15

The method of Claim 14, wherein the coupling includes at least one of welding, soldering, and adhering.

### Embodiment 16

The method of Claims 14 or Claim 15, further comprising containing a medium escaping a seam between the first member and the second member within the cavity of the partial pipe.

### Embodiment 17

The method of any of Claims 14-16, further comprising maintaining a pressure within a shell side of the heat exchange device with the partial pipe.

In addition to the various embodiments depicted and claimed, the disclosed subject matter is also directed to other embodiments having any other possible combination of the features disclosed and claimed herein. As such, the particular features presented herein can be combined with each other in other manners within the scope of the disclosed subject matter such that the disclosed subject matter includes any suitable combination of the features disclosed herein. Furthermore, although reference is made to a partial pipe throughout this disclosure, other suitable devices can be repaired using the system and method disclosed herein. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the system and method of the disclosed subject matter without departing from the spirit or scope of the disclosed subject matter. Thus, it is intended that the disclosed subject matter include modifications and variations that are within the scope of the appended claims and their equivalents.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. “Or” means “and/or.” The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The modifier “about” used in connection with a quantity is inclusive of the stated value and has the meaning dictated by the context (e.g., includes the degree of error associated with measurement of the particular quantity). The notation “±10%” means that the indicated measurement can be from an amount that is minus 10% to an amount that is plus 10% of the stated value. The terms “front”, “back”, “bottom”, and/or “top” are used herein, unless otherwise noted, merely for convenience of description, and are not limited to any one position or spatial orientation. “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs. A “combination” is inclusive of blends, mixtures, alloys, reaction products, and the like.

All cited patents, patent applications, and other references are incorporated herein by reference in their entirety. However, if a term in the present application contradicts or conflicts with a term in the incorporated reference, the term from the present application takes precedence over the conflicting term from the incorporated reference

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/We claim:

1. A system for repairing a shell and tube heat exchange device, comprising:
a shell and tube heat exchange device having a longitudinal dimension and a housing, the housing having at least a first member and a second member disposed along a longitudinal side of the exchange device; and
a partial pipe having a first end, a second end, and a continuous interior surface, the partial pipe coupled to the housing transverse to the longitudinal direction, wherein the first end of the partial pipe is coupled to the first member and the second end of the partial pipe is coupled to the second member to define a cavity between the continuous interior surface of the partial pipe and the longitudinal side of the exchange device and to prevent leakage of the exchange device.

2. The system of claim 1, wherein the shell and tube heat exchange device includes a plurality of tubes, a first tube sheet, and a second tube sheet, wherein the plurality of tubes are coupled to and extend between the first tube sheet and the second tube sheet.

3. The system of claim 2, wherein a first medium flows within the plurality of tubes at a tube side of the heat exchange device and a second medium flows exterior of the plurality of tubes within the housing at a shell side of the heat exchange device.

4. The system of claim 1, wherein the shell side withstands a predetermined pressure load.

5. The system of claim 1, wherein the first member and the second member define a seam.

6. The system of claim 5, wherein the seam includes a fissure that alters a pressure within a shell side of the heat exchange device and the plurality of tubes withstand the pressure alteration.

7. The system of claim 6, wherein the partial pipe contains the fissure between the first end and the second end of the partial pipe.

8. The system of claim 1, wherein the partial pipe comprises a flexibility profile that enables the partial pipe to maintain structural integrity upon deformation of the housing.

9. The system of claim 1, wherein the partial pipe comprises steel.

10. The system of claim 1, wherein the first member comprises a bracket that couples at least one of the first tube sheet or the second tube sheet to the housing.

11. The system of claim 1, wherein the first member and the second member each comprise a panel of the housing.

12. The system of claim 1, wherein the partial pipe is coupled to the first member and the second member by at least one of weld, solder, and adhesive.

13. The system of claim 1, wherein the continuous interior surface of the partial pipe is uninterrupted.

14. A method of repairing a shell and tube heat exchange device, comprising:
providing a shell and tube heat exchange device having a longitudinal dimension and a housing, the housing having at least a first member and a second member disposed along a longitudinal side of the exchange device; and
coupling a partial pipe to the housing transverse to the longitudinal direction, wherein the partial pipe has a first end, a second end, and a continuous interior surface, the first end of the partial pipe coupled to the first member and the second end of the partial pipe coupled to the second member to define a cavity between the continuous interior surface of the partial pipe and the longitudinal side of the exchange device and to prevent leakage of the exchange device.

15. The method of claim 14, wherein the coupling includes at least one of welding, soldering, and adhering.

16. The method of claim 14, further comprising containing a medium escaping a seam between the first member and the second member within the cavity of the partial pipe.

17. The method of claim 14, further comprising maintaining a pressure within a shell side of the heat exchange device with the partial pipe.
